(19) United States
(12) Patent Application Publication
(10) Pub. No.: US 2018/0288992 A1
(43) Pub. Date: Oct. 11, 2018

(54) Insect Trap To Control Mosquito Population

(71) Applicant: Yuri M. Gallegos, Plainfield, IL (US)

(72) Inventor: Yuri M. Gallegos, Plainfield, IL (US)

(21) Appl. No.: 15/423,588

(22) Filed: Apr. 10, 2017

(51) Int. Cl. A01M 1/06; A01M 1/10; A01M 1/02

(52) U.S. Cl. CPC A01M 1/06; A01M 1/023; A01M 1/106

(57) ABSTRACT

An insect-trap (200), which is composed of a cover (30) with a fan (40) which blows air inside of the container (20). The airflow created by the fan (40) suction mosquitoes into the container while the airflow that leaves the cover thru the outlet (32) is collecting the aroma from the attractant (80) which is very effective at luring mosquitoes to come closer. The outlet (32) allows air flow and prevents mosquitoes from escaping the trap (200). The container (20) can hold different kinds or a combination of attractants (80).

### CROSS-REFERENCE TO RELATED APPLICATIONS

None

### FEDERALLY SPONSORED RESEARCH

None

### SEQUENCE LISTING OR PROGRAM

None

### BACKGROUND—PRIOR ART

The following is a tabulation of some prior art that presently appears relevant:

U.S. Patents

| Patent Number | Kind Code | Issue Date | Patentee |
|---|---|---|---|
| 6,145,243 | A | Nov. 14, 1000 | Bruce E. Wigton et |
| 6,286,249 | B1 | Sep. 11, 1001 | Mark H. Miller et al. |
| 6,305,122 | B1 | Oct. 23, 1001 | Kenzou lwao et al. |
| 6,055,766 | A | May. 2, 1000 | James A. Nolen et |
| 9,192,165 | B2 | Nov. 24, 2015 | Andreas Rose et al. |
| 9,049,855 | B2 | Jun. 9, 2015 | Juan J. Rocha. |

U.S. Patent Application Publications

| Publication Nr. | Kind Code | Pub. Dt. | Applicant |
|---|---|---|---|
| 0066570 | A1 | Mar. 31, 1005 | Robert F. Mosher II. |
| 0059918 | A1 | Mar. 6, 2014 | Fen Lin. |
| 0021866 | A1 | Jan. 28, 2016 | Qiwu LI. |
| 0064679 | A1 | Mar. 14, 2013 | Yi-Yi TSAI |

Biting insect, such as mosquitoes and flies, can create health problem because they are vectors for transmitting diseases such as Zika, Dengue, Malaria, Yellow fever and West Nile Virus to mention some. Worldwide, mosquito borne diseases kills more people than any other single factor. In the United States, mosquitos spread several types of encephalitis, and lately the Zika virus is starting to spread in warm places such as Florida, Texas and California. They also transmit heart worms to cats and dogs.

Mosquitos are attracted to a host by the carbon dioxide (CO₂) produced during normal breathing, Moisture from sweat, heat from warm bodies, scent, and sight. From 100 feet away (30 meters) mosquitos are able to smell a blood host's scent, especially the CO₂ the host normally exhales.

Previously people have tried a number of different methods to eliminate mosquitoes and other biting insects. One method that is often utilized is spraying or applying chemical insecticides. Although many chemicals work well to kill or repel mosquitoes, the chemicals often have a negative effect on the environment, including, but not limited to, killing beneficial insects such as bees. In addition, chemical insecticides are effective only for a limited amount of time, and thus must be continuously sprayed. Moreover, many types of mosquitoes and biting insects are capable of developing resistance to chemical pesticides in a few generations (which may be only a few months for mosquitos), and in the long run, that adaptation makes the species stronger.

Citronella candles and smoking coils are often used to repel mosquitos and other insects. However, research has shown that, in general, an individual must stand within the smoky plume of the citronella to be protected. This, of course, is not desirable. Moreover, even when standing in the plume, citronella is only partially effective in reducing the probability of a mosquito bite. Encouraging natural predation of insects by setting up bird or bat houses in one's backyard has also been unsuccessful in reducing local mosquito populations. Mosquitoes are very small weighting 2.5 milligrams and do not provide sufficient nutrition to predators.

Recently, significant research and effort have been expended to develop devices that attract and trap or kill mosquitos. In general, these devices attempt to replicate the mosquito-attracting attributes of a typical blood host, such as a rabbit or a bird. The devices may include, for example, a source of carbon dioxide, a source of octenol (an alcohol that is given off by mammalian blood hosts), and/or a heat source.

One such device is sold under the trademark “MOSQUITO MAGNET” and is described in U.S. Pat. No. 6,145,243 to Wigton et al. The MOSQUITO MAGNET apparatus is an insect trapping device that generates its own insect attractants of carbon dioxide (CO₂), heat, and water vapor through catalytic conversion of a hydrocarbon fuel in a combustion chamber. The hot insect attractants generated in the combustion chamber are diluted and cooled to a temperature above ambient temperature and below about 115 degrees Fahrenheit (F) by mixing with air, and the mixture is exhausted downward through an exhaust tube. A counter flow of outside air is drawn into the trap though a suction tube that concentrically surrounds the exhaust tube. Biting insects are sucked into the suction tube and are captured in a porous, disposable bag connected to the other end of the suction tube. Additional chemical attractants may be used with the device to make the trap even more effective.

Although the MOSQUITO MAGNET device works well for its intended purpose, due to the high suggested retail price, especially for its cordless models, it is far out of reach of the ordinary consumer. Thus, few people would actually purchase the MOSQUITO MAGNET, even if they have a pressing need for mosquito control.

Another example of an apparatus for attracting and destroying insects is disclosed in U.S. Pat. No. 6,055,766, and is sold under the trademark DRAGONFLY. The DRAGONFLY apparatus generally includes a source of carbon dioxide, a source of octenol, a device for emitting the carbon dioxide proximate the source of octenol to create a mixture of the carbon dioxide and octenol, a heating element, and an electrified grid. Insects are initially attracted to the apparatus by the odor associated with the mixture of carbon dioxide and octenol. As the insects fly closer to the apparatus, they are further attracted to the visual properties of the apparatus and then, at close range, they are attracted to the heat emitted by the heating element. In an attempt to fly closer to the heating element, the insects are intercepted by the electrified grid and destroyed.

Although the DRAGONFLY apparatus works well for attracting and capturing insects, because the direct current type mosquito trap electrocutes mosquitoes using direct current, it creates a dangerous situation for people, especially for children; as with the MOSQUITO MAGNET device, the DRAGONFLY apparatus has a pricing point out of the range of the ordinary consumer.

Another mosquito trap is disclosed in U.S. Pat. No. 9,049,855 and is sold under the trademark DYNATRAP, is one of the many other traps available that uses Ultraviolet (UV) light to attract mosquitoes. Unfortunately is effective at attracting light sensitive insects such as moths, fireflies, butterflies, bees and a variety of others beneficial insects that use light to either attract a mate or finding food on flowering plants. Many consumers of these traps complain that mosquitos are no eliminated or reduced in numbers. The present invention is made of fewer components and simple design that will reduce the cost of the device so it can be installed in many places and control mosquito population. This will reduce the number of people getting bitten, sick or dying from mosquito transmitted diseases.

### SUMMARY

In accordance with one embodiment a mosquito-trap comprises of a powerful fan to drag attracted flying insects into the container and trapping them, at the same time it lets air out through a screened outlet dispersing the aroma of the attractant left inside of the container to lure more mosquitos in.

### Advantages

Accordingly several advantages of one or more aspects are as follows: to provide a mosquito trap that is efficient at attracting and trapping mosquitos controlling their population which as a result will reduce or eliminate the spread of mosquitoes which are vectors for transmitted diseases such as Zika, Dengue, Yellow fever and West Nile virus, to name a few of different tropical diseases. The device of this invention uses very little energy and it can be used anywhere inside or outside the house. Many different attractants can be used including octanol, L-Lactic acid, Nonanal, yeast CO₂ generators or a combination of all of them. Also water has an increase effect attracting mosquitoes when using in combination with any of the attractants described above.

All of the above mentioned attractants are biodegradable and they are not poisonous in any way to people or insects and do not represent a danger to people in general, this makes the mosquito-trap safe and secure to be used by anyone.

### DRAWINGS—FIGURES

In the drawings, closely related figures have the same number but different alphabetic suffixes.

FIG. 1 is an isometric view of the mosquito trap.

FIG. 2 is an exploded view of the mosquito-trap.

FIG. 3 is a perspective view of the underside of the cover.

FIG. 4 is a cross-sectional view of the mosquito-trap.

FIG. 5 is an isometric view of a second embodiment of the mosquito trap.

FIG. 6 is a section view of a second embodiment of the mosquito trap.

### DRAWINGS—REFERENCE NUMERALS

10. Mosquito.
20. Bucket/Open Container.
21. Rim.
30. Cover.
31. Inlet.
32. Outlet.
33. Screw-boss.
34. Snap-Lock.
35. Connector Cutout.
40. DC Fan.
50. Screw.
60. Micro-USB Connector.
70. USB Charger.
72. USB cable.
80. Attractant.
90. Airflow.
100. Mosquito-trap
first embodiment.
110. Container.
111. Inlet.
112. Outlet.
113. Cable-hole.
120. AC Fan.
125. Power-cable.
126. AC-plug.
130. Screen.
140. Attractant.
150. Airflow.
200. Mosquito-trap
Second embodiment.

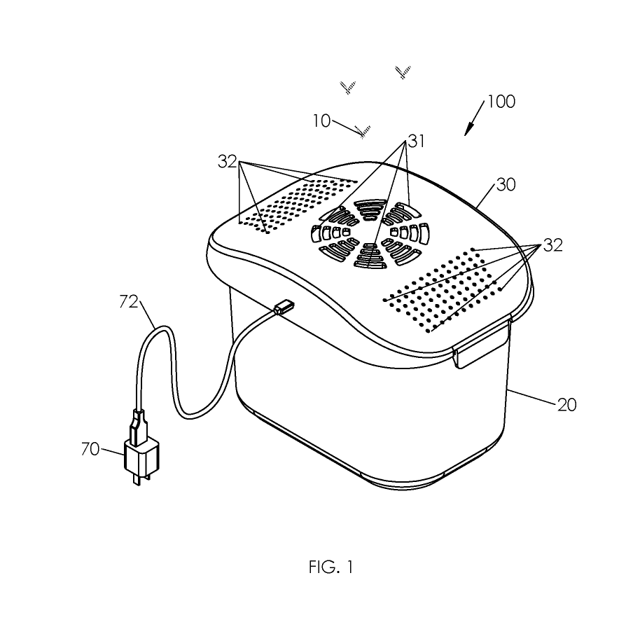

### DETAILED DESCRIPTION—FIGS. 1, 2, 3—FIRST EMBODIMENT

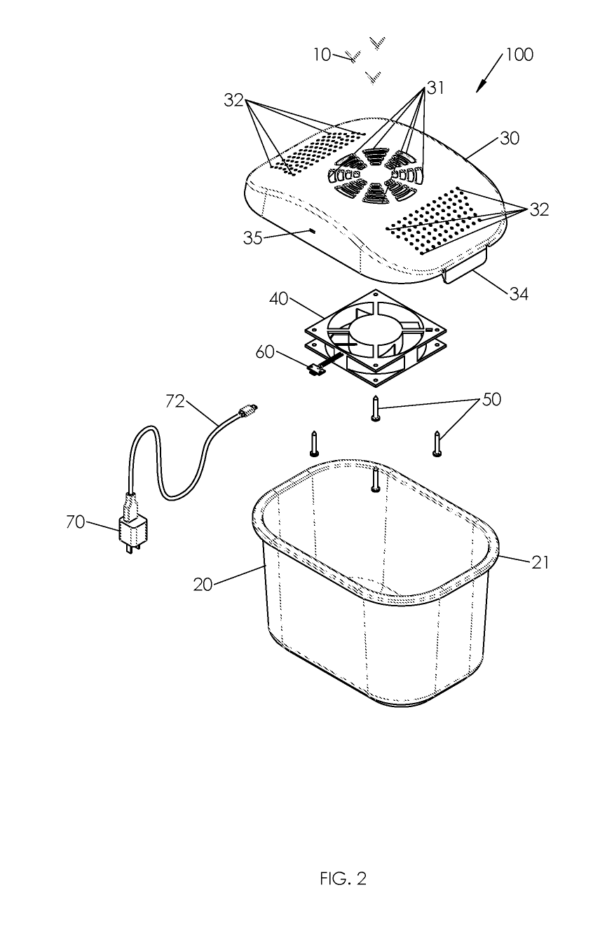

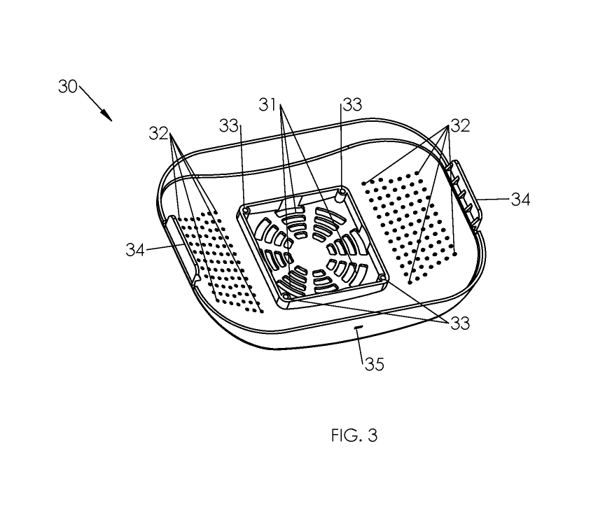

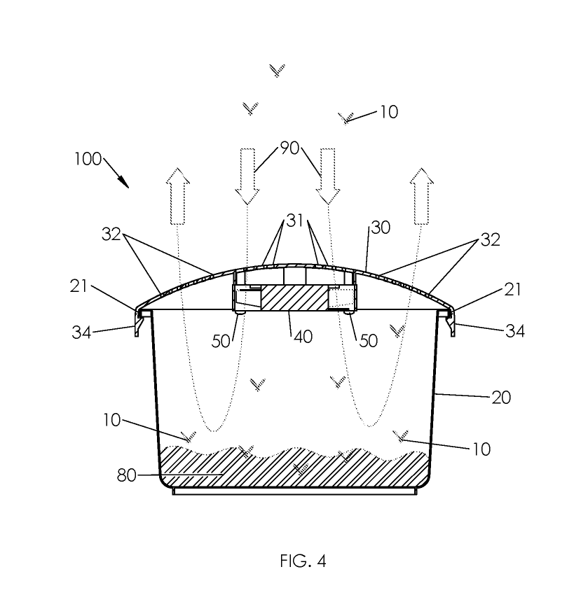

A preferred first embodiment of a mosquito-trap 100 is illustrated in FIG. 1 that shows a general view of the device. An exploded view shown in FIG. 2 displays in more detail the rest of components. The device has a cover 30 made of polypropylene plastic with an inlet 31 made of a plurality of openings arranged in a circular pattern of an appropriate size to protect people fingers, but big enough to let a mosquito 10 to pass thru. The cover 30 houses inside a DC-fan 40 with airflow of 110 CFM, and 2500 RPM; with a size of 120×120×38 mm, 5 VDC, 0.18 A. (Also can be used an AC fan rated at 120 VAC, 0.2 A.) The DC-fan 40 is held in place using a few self-taping M4 screws 50 that mount on a screw-boss 32 of the cover 30, shown in FIG. 3. The cover 30 has outlets 32 made of a plurality of holes arranged in a rectangular matrix similar to a mosquito netting with approximately 400 holes per square inch to prevent mosquitoes 10 from escaping. The cover 30 is mounted on a bucket 20 made of polypropylene and held in place by a snap-lock 34 that attaches to a rim 21 of the bucket 20. The cover 30 in FIG. 3 has a connector-cutout 35 where a micro-USB connector 60 is press fit, and that connects to the DC-fan 40 to supply power. The DC-fan 40 is then powered using a USB-charger 70 and provided with a USB cable 72 to connect to the micro-USB connector 60. An attractant 80 is placed inside the bucket 20. The attractant 80 can be made with various substances available in the market such as Octenol, L-Lactic acid, Nonanal, or a combination. The attractant 80 can be in a liquid, gel, solid or gas state.

### OPERATION—FIG. 1, 4—FIRST EMBODIMENT

The mosquito-trap 100 operates by placing the attractant 80 inside the bucket 20 and installing the cover 30 until the snap-lock 34 attaches securely to the rim 21 of the bucket 20. Once the DC-fan 40 is powered by connecting the USB-cable 72 and USB-charger 70 to power; it creates an airflow 90 thru the inlet 31 of the cover 30 and going inside the bucket 20. The airflow 90 collects any of the Carbon dioxide (CO₂), moisture or aroma produced by the attractant 80, and leaving by the outlets 32 to effectively spread the CO₂, moisture or aroma outside of the trap 100. Once the mosquitoes 10 detect the CO₂ and moisture aroma of the attractant 80, their senses are activated and come closer to the cover 30 where the powerful airflow from the DC-fan 40 draws them inside the bucket 20 where they hit the bottom of the bucket 20 or fall in the attractant 80 and die. The mosquitoes 10 that do not fall in the attractant 80 fly to the outlets 32 where they cannot pass and after some time they get desiccated by the leaving airflow 90 or die by starvation in a couple of hours. The attractant 80 works by spreading Carbon dioxide (CO₂) in conjunction with moisture which is a powerful attractant of aedes aegypti mosquitoes which are a vector for Zika, Dengue, yellow fever and many other tropical diseases. Once the trap 100 is full of dead mosquitoes 10, the cover 30 can be removed by unlatching the snap-locks 34 from the rim 21 of the bucket 20, and the contents of dead mosquitoes 10 can be disposed in the garbage or use as fertilizer for garden plants. Certainly different attractants 80 such as Octenol, L-Lactic acid, Nonanal or a combination can be used. The attractant 80 can be in liquid, gel, solid or gas state at all times.

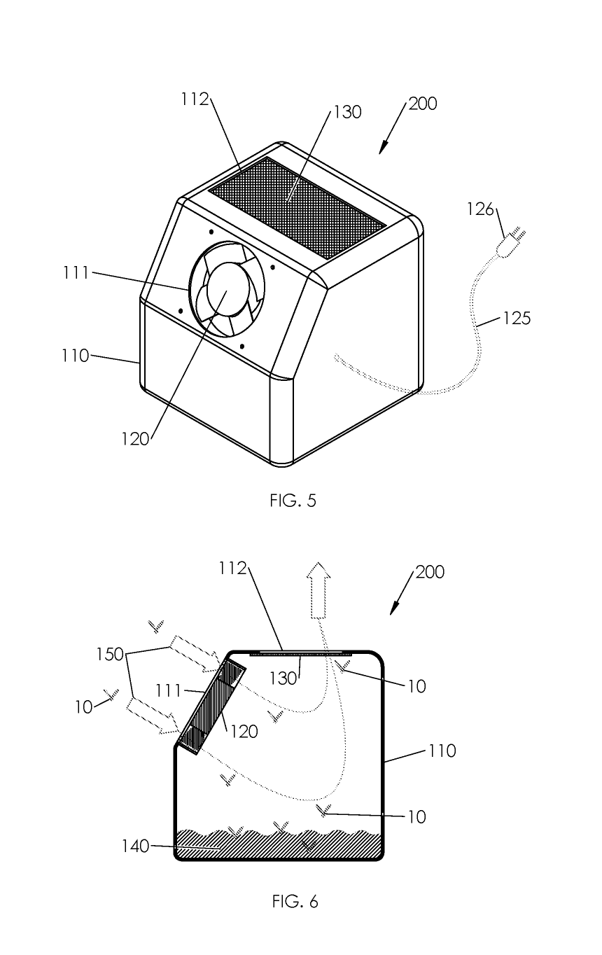

### DESCRIPTION—ALTERNATIVE EMBODIMENT—FIGS. 5 AND 6

An alternate embodiment is shown in FIGS. 5 and 6, where a plastic container 110 provided with an inlet 111, an outlet 112 and a cable-hole 113 is shown. The inlet 111 is made of a circular opening and sized to let enough airflow 150 to go thru. The rectangular in shape outlet 112 is covered with a screen 130 with approximately 400 holes per square inch. An AC-fan 120 is mounted behind the inlet 111, and provided with a power-cable 125 terminated on an electrical-power-plug 126. The power-cable 125 can pass thru the cable-hole 113 of the container 110. The power-cable 125 works with 120 VAC although other voltages can be used. An attractant 140 can be located inside the container 110. The attractant 140 can be a liquid, gel, solid or gas.

### OPERATION—ALTERNATIVE EMBODIMENT—FIG. 6

The operation of the alternate embodiment of the mosquito-trap 200 starts by powering the AC-fan 120 by connecting the AC-plug 126 to an electrical outlet (not shown). The airflow 150 that the AC-fan 120 creates goes inside the container 110 collecting the aroma of the attractant 140 and escapes by the outlet 112. Once a mosquito 10 detects the leaving aroma of the attractant 140, it comes closer to the mosquito-trap 200 where the AC-fan 120 will draw it inside the container 110 where they die by hitting the inside of the container 110, by desiccation provide by the airflow 90, or by starvation in a couple of hours.

### CONCLUSION, RAMIFICATIONS, AND SCOPE

Accordingly the reader will see that, according to one embodiment of the invention, I have provided an improved mosquito trap that will help control and reduce mosquito population and eliminate disease transmitting mosquitos from a human populated area. This effective solution can be used by any person to protect themselves from mosquitoes and has many other advantages in that:
It attracts and traps mosquitos efficiently by the powerful fan.
It reduces the mosquito population and therefore reducing the risks of getting diseases transmitted by biting insects.
It's made of Polypropylene, ABS and polyethylene that are both recyclable and biodegradable.
Its small profile makes is easier to install anywhere in the back yard, front yard or even inside the house to catch mosquitos that get inside thru the door when people leaves or comes in the house.
It uses very little power (5 Watts.) due to the use of a powerful but efficient fan.
By using a quiet fan it does not produce a bothering sound that can disturb people while sleeping or reading.
Kids and adults are able to use it very quickly, with minimal training.
Different attractants certainly can be used including Octenol, L-Lactic acid, Nonanal or a combination.
The attractants contrary to pesticides are safer and do not represent a danger to people in general.
   Although the description above contains many specificities, these should not be construed as limitations on the scope of any embodiment, but as exemplifications of various embodiments thereof. Many other ramifications and variations are possible within the teachings of the various embodiments. For example:
Many different types of fans can be used that use different power voltages (AC or DC), or even solar powered by solar cells, or that are more reliable and economical for manufacturing and sale.
The fan can be mounted vertically, horizontally or at an angle, provided that the cover or containers are suitable to the new mounting configuration.
The cover can be placed in almost any container and still function. Different container sizes and capacities can be used.
The cover and container can have many different shapes such as oval, circular, triangular, square or rectangular.
The fan can be mounted directly on the container instead of a cover reducing the number of parts and simplifying the design.
The fan can be mounted using screws, silicone mount screws, snap fit locks, or simply glued with epoxy, etc.
The screen can be molded directly on the cover or container instead of installing screens, or mosquito nets.
The outlets and screen for air exhaust can be placed directly on the container instead of the cover.
The screens can be made by photo fabrication on thing sheet metal and heat or ultrasonically welded to the plastic container or cover.
The screen can be an in-mold component that is added during the injection molding of the cover saving time during manufacturing.
Different types of attractants can be used gas, liquid, paste, solid or a combination.

Thus the scope should be determined by the appended claims and their legal equivalents, and not by the examples given.

1. A device for attracting and trapping insects, comprising:
a. a cover having one or a plurality of inlets, and one or a plurality of outlets;
b. a fan mounted inside said cover; and
c. an open container with vacant space therein where said cover can be mounted;
whereby, insects can be collected to prevent bites and the spread of diseases.

2. The device for attracting and trapping insects of claim 1 wherein said cover has first means to retain said fan.

3. The device for attracting and trapping insects of claim 1 wherein said cover has holding means to attach to said open container.

4. The device for attracting and trapping insects of claim 1 wherein said cover has screened outlets.

5. The device for attracting and trapping insects of claim 1 wherein said cover has molded in screened outlets in said cover.

6. The device for attracting and trapping insects of claim 1 wherein a substance that attracts insects is placed inside said open container.

7. A device for attracting and trapping insects, comprising:
a. a closed container having one or a plurality of inlets, and one or a plurality of outlets with vacant space therein; and
b. a fan mounted inside said closed container;
whereby, insects can be collected inside to prevent bites and spread of diseases.

8. The device for attracting and trapping insects of claim 7 wherein said container has holding means to retain said fan.

9. The device for attracting and trapping insects of claim 7 wherein a substance that attracts insects is placed inside said container.

10. A method for attracting and trapping insects comprising a fan inside a container to draw insects inside and collecting them.

11. The method of claim 10 wherein container has an insect attracting substance.
